(19) United States
(12) Patent Application Publication
(10) Pub. No.: US 2021/0293649 A1
(43) Pub. Date: Sep. 23, 2021

(54) FIELD AIR PRESSURE SENSOR CALIBRATION FOR END-OF-TRAIN DEVICES

(71) Applicant: DPS Electronics, Inc., Bozeman, MT (US)

(72) Inventor: C. Adam Lamb, Bozeman, MT (US)

(21) Appl. No.: 17/206,920

(22) Filed: Mar. 19, 2021

Related U.S. Application Data
(60) Provisional application No. 62/992,312, filed on Mar. 20, 2020.

(51) Int. Cl. G01L 27/00; B60T 13/66

(52) U.S. Cl. CPC G01L 27/005; B60T 13/662

(57) ABSTRACT

A brake line pressure sensor calibration system for an end of train device includes one or more computer processors, a display screen, and a sensor configured to measure the brake line pressure of the train. The processors are configured to implement a calibration of the sensor, guide a user through a sensor calibration, and acquire calibration data during the calibration. The processors guide the user through the calibration by generating calibration instructions, which the display screen displays, and receiving input responsive to the instructions. To perform the calibration, the sensor acquires at least one pressure measurement of a controlled air pressure applied to the sensor in response to a pressure setpoint input by the user in accordance with the calibration instructions. The device includes an internal memory configured to store the calibration expiration data, which is also displayed on the display screen.

### CROSS-REFERENCE TO RELATED APPLICATION

This application claims priority to U.S. Provisional Application Ser. No. 62/992,312, filed Mar. 20, 2020, and entitled “FIELD AIR PRESSURE SENSOR CALIBRATION FOR END OF TRAIN DEVICES”, which is incorporated by reference herein in its entirety for any purpose.

### TECHNICAL FIELD

Implementations relate to devices, systems, and methods for calibrating a brake line pressure sensor of a train. Specific implementations include a device mounted on a train and configured to direct the calibration of a brake line pressure sensor housed within the device using at least one computer processor and a display screen configured to display calibration instructions and acquired calibration data.

### BACKGROUND

End-of-train devices are used in the railroad industry to relay telemetry information from the back of a train to a head-of-train device located in the locomotive via a 450 MHz radio. In addition, end-of-train devices provide a supplemental emergency braking function on a train in the event of an emergency that requires a train to stop quickly. As part of their function, all end-of-train devices approved by the American Association of Railroads and Federal Railroad Administration are equipped with an air pressure sensor to measure the brake line pressure at the end of the train. This sensor is required to be calibrated against a known good and calibrated air pressure sensor at least once every 368 days per Federal Railroad Administration rules.

Sometimes units out in the field have their calibration expire without users of the devices realizing this has occurred, which can result in significant multi-thousand dollar fines to the railroads, and much more importantly, can result in potentially unsafe operating conditions in the event the pressure measurements being made by the end-of-train device are no longer accurate. Companies that utilize end-of-train devices typically send a unit either back to a manufacturer or to one of a few centralized locations within their company that has specialized equipment setup to calibrate the air pressure sensor on an end-of-train device.

### SUMMARY

Implementations of the present disclosure include firmware/software devices, systems, and methods that incorporate certain existing hardware features of a standard end-of-train device approved by the American Association of Railroads to facilitate a rapid field calibration of the brake line air pressure sensor of the end-of-train device with only a controllable air source and a calibrated air pressure measurement reference. This prevents the need to ship the device to a location with specialized equipment.

In accordance with embodiments of the present disclosure, an end of train device programmed to calibrate a brake line pressure sensor of the end of train device includes a sensor configured to measure the brake line pressure of the train; one or more processors configured to implement a calibration of the sensor; guide a user through the calibration of the sensor by generating calibration instructions and receiving user input responsive to the instructions; and acquire calibration data during the calibration; a memory configured to store the acquired calibration data; and a display screen on the end of train device configured to display the calibration instructions.

In some embodiments, the calibration instructions include a request to provide the sensor with at least one pressure setpoint. In some embodiments, the one or more processors are further configured to cause the sensor to acquire at least one pressure measurement of a controlled air pressure applied to the sensor for each pressure setpoint. In some embodiments, the calibration data includes calibration values determined by comparing the at least one pressure setpoint with the at least one pressure measurement acquired by the sensor on the end of train device. In some embodiments, where the one or more processors are further configured to determine whether the calibration values are within a defined tolerance range. In some embodiments, the one or more processors are further configured to cause the display screen to display an alert if the calibration values are not within the defined tolerance range.

In some embodiments, the calibration data includes calibration values, a calibration status, a date and time of the calibration, a location of the calibration, a time until a next calibration is due, a pressure measurement obtained during the calibration, and/or a pressure setpoint entered by the user during the calibration. In some embodiments, the one or more processors are further configured to transmit the calibration data to a remote office. In some embodiments, one or more processors are configured to initiate the calibration of the sensor by at least one of: detecting a rapid air pressure modulation caused by the user, detecting a dongle attachment to the device, detecting a manual button-press sequence received at an arm button on the device, and/or receiving a command from a wirelessly coupled device.

In some embodiments, the one or more processors are further configured to cause the sensor to acquire at least one pressure measurement of a controlled air pressure applied to the sensor and compare the at least one air pressure measurement against voltage and RPM signals from an air turbine generator on the end of train device. In some embodiments, the one or more processors are configured to determine if the compared values are within a defined tolerance range based on specifications for the air turbine generator.

In some embodiments, the one or more processors are further configured to cause the display screen to display an alert based on a time remaining until a next calibration is due. In some embodiments, the one or more processors are further configured to disable the device when calibration is overdue.

In accordance with some embodiments of the present disclosure, a system programmed to calibrate a brake line pressure sensor of an end of train device includes a controllable air source; a sensor on the end of train device configured to measure brake line air pressure applied by the controllable air source; a first processor on the end of train device configured to: implement a calibration of the sensor; and acquire calibration data during the calibration; a second processor wirelessly coupled to the end of train device configured to: guide a user through the calibration of the sensor by generating calibration instructions and receiving user input responsive to the instructions; and display calibration instructions on a display screen.

In some embodiments, the calibration instructions includes a request to provide the sensor with at least one pressure setpoint. In some embodiments, the one or more processors are configured to initiate the calibration of the sensor by detecting a rapid air pressure modulation caused by the user, detecting a dongle attachment to the device, detecting a button-press sequence received at an arm button on the device, and/or receiving a command from a wirelessly coupled device.

In accordance with further embodiments of the present disclosure, a method of calibrating a brake line pressure sensor on an end of train device, including initiating a calibration mode on the end of train device, where the device houses the brake line pressure sensor; guiding a user through a calibration of the brake line pressure sensor by generating and displaying calibration instructions on the device; requesting at least one pressure setpoint be provided to the brake line pressure sensor; acquiring at least one pressure measurement of the defined brake line air pressure; acquiring calibration data by comparing the at least one pressure measurement to the at least one pressure setpoint; storing the calibration data within the device; and displaying the calibration instructions.

In some embodiments, the method involves initiating the calibration mode on the device includes detecting a rapid air pressure modulation caused by the user, detecting a dongle attachment to the device, detecting a button-press sequence received at an arm button on the device, and/or receiving a command from a wirelessly coupled device. In some embodiments, the method involves disabling the device when calibration is overdue.

### BRIEF DESCRIPTION OF THE DRAWINGS

FIG. 1 is an illustration of an end-of-train device attached to a train in accordance with embodiments of the present disclosure.

FIG. 2 is a schematic diagram showing end-of-train device components in accordance with embodiments of the present disclosure.

FIG. 3 is an illustration of a brake line air pressure sensor calibration system implemented in accordance with preexisting technology.

FIG. 4 is an illustration of a brake line air pressure sensor calibration system implemented in accordance with embodiments of the present disclosure.

FIG. 5 is an illustration of another brake line air pressure sensor calibration system implemented in accordance with embodiments of the present disclosure.

FIG. 6 is an illustration of a preexisting end-of-train device.

FIG. 7 is an illustration of an end-of-train device implemented in accordance with embodiments of the present disclosure.

### DETAILED DESCRIPTION

When an end-of-train device is found to be out of calibration while about to be put into service in the field, the devices, systems, and methods disclosed herein will allow it to be quickly and easily calibrated, with the new calibration status information being automatically updated, logged into internal memory logs, and displayed to a user.

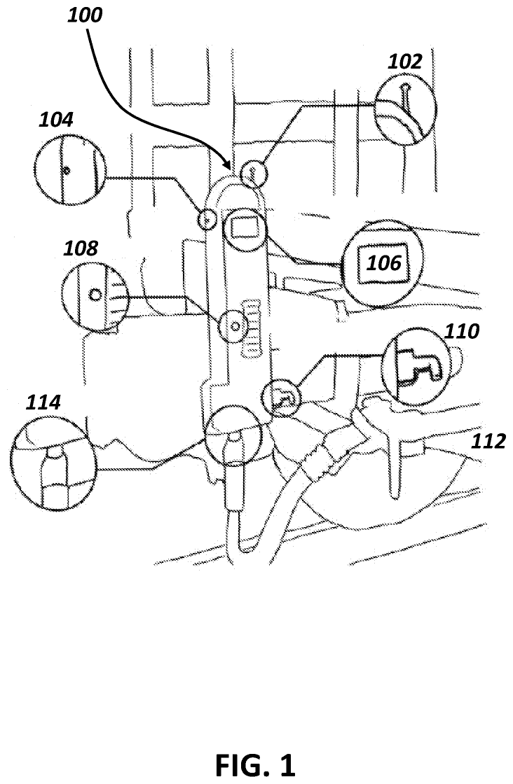

As shown in FIG. 1, an end-of-train device 100 can include an antenna 102, which can be configured for a 450 MHz telemetry radio. The end-of-train device 100 can also include a high-visibility marker 104, a display 106 for pressure data and other information, an arm/test button 108, a clamp 110 to fasten the device to a train 112, and a brake pipe hose 114.

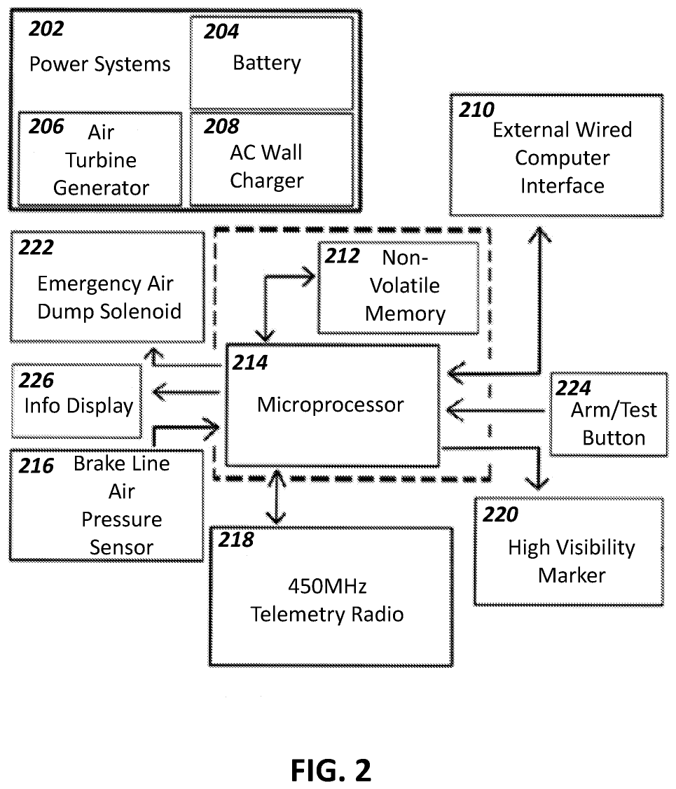

FIG. 2 is a block diagram of the components that can be included within and/or on an end-of-train device, such as the end-of-train device 100 depicted in FIG. 1. The components include power systems 202, which can include a battery 204, an air turbine generator 206, and an AC wall charger 208. The device components may also include an external wired computer interface 210, e.g., a USB/RS-232, a non-volatile memory 212, and one or more processors, which may include a microprocessor 214. The components can also include a brake line air pressure sensor 216, a 450 MHz telemetry radio 218, a high visibility marker 220, an emergency air dump solenoid 222, an arm/test button 224, and an informational display 226.

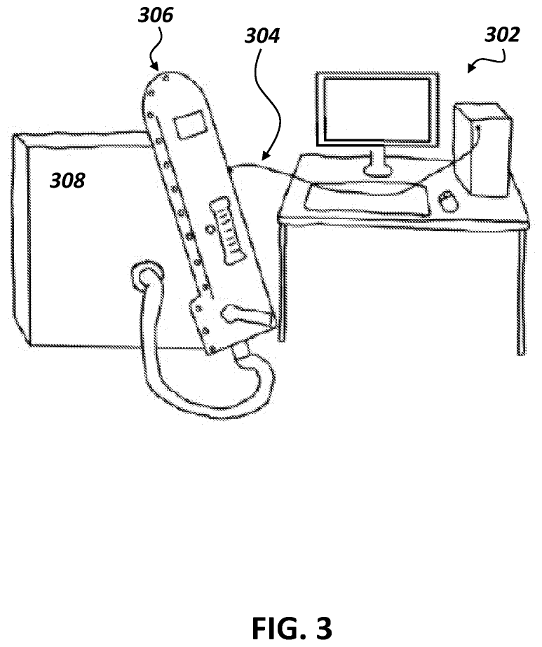

Preexisting calibration systems for the brake line pressure sensor of a train typically require a combination of equipment that is usually only offered in a benchtop environment. As shown in FIG. 3, such equipment usually includes a personal computer 302 running custom software from the vendor of an end-of-train device 306, a wired connection 304 (e.g., a wired cable (like USB or a serial UART cable)) running from the computer 302 to the end-of-train device 306, an air pressure source 308, and a calibrated air pressure sensor reference (also represented by 308).

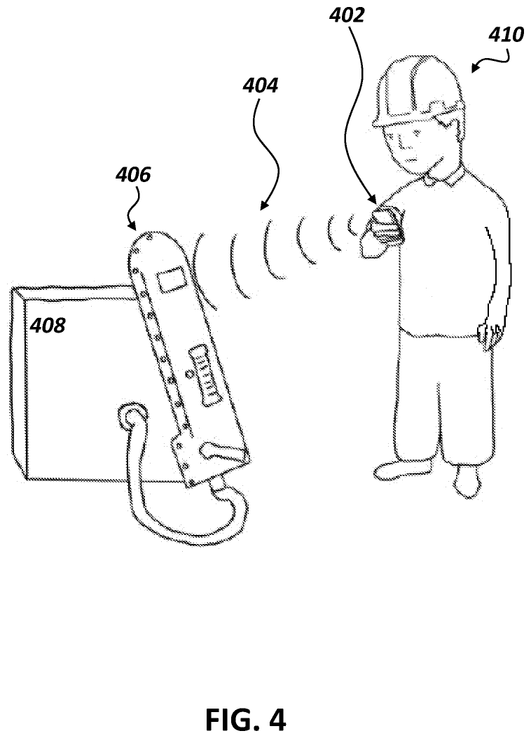

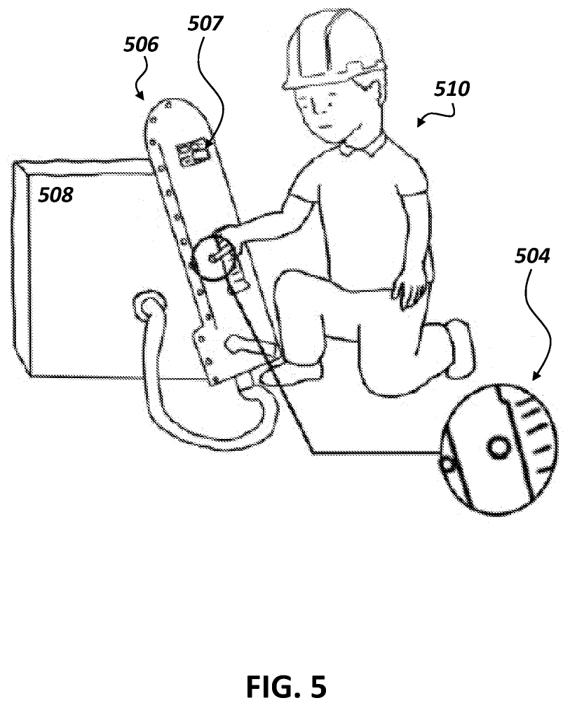

End-of-train devices such as those described herein (e.g., devices 406 and 506, depicted in FIGS. 4 and 5, respectively) are often used in the railroad industry to relay telemetry information from the back of a train to a head-of-train device located in the locomotive via the 450 MHz radio 218. In addition, end-of-train devices provide a supplemental emergency braking function (for example via the emergency air dump solenoid 222) on a train in the event of an emergency that requires a train to stop quickly. As part of their function, all end-of-train devices approved by the American Association of Railroads and Federal Railroad Administration devices are equipped with an air pressure sensor (e.g., brake line air pressure sensor 216) to measure the brake line pressure at the end of the train. This sensor is required to be calibrated against a known good and calibrated air pressure sensor (see controllable air sources 308, 408, 508 of FIGS. 3, 4, and 5, respectively) at least once every 368 days per Federal Railroad Administration rules.

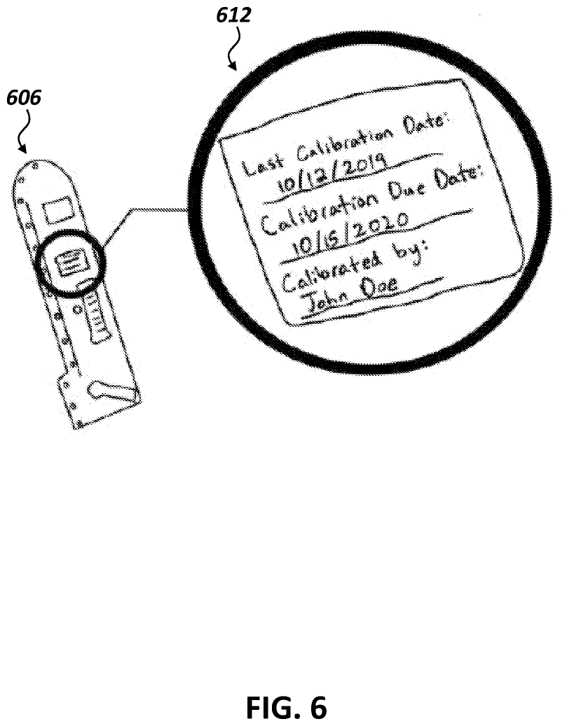

The first advantage of the technology disclosed herein is that the calibration information (typically represented by the last calibration date, the next calibration date, and the name of the person that last calibrated the unit) can be moved from an external sticker (see sticker 612 of FIG. 6) to a non-volatile memory (e.g., non-volatile memory 212) housed within a disclosed end-of-train device, such as the end-of-train devices 406 and 506 depicted in FIGS. 4 and 5, respectively. Once the official calibration information has been moved and stored into the non-volatile memory of the end-of-train device 406/506, the device can then display (for example via display screen 106, 507) the calibration information to the user when the device is turned on.

In normal operation, and when the next calibration is not due soon, a disclosed end-of-train device 406/506 can display pertinent calibration information to the user several times upon power up, then cease to display this information. If a calibration is due soon (within 14 days for example), the display can continue cycling this information on the display with other important information as long as the display is turned on.

If a calibration is coming due soon, a disclosed end-of-train device 406/506 can also send alerts to a centrally located back office to alert the operator(s) working therein that a calibration is coming due, thereby allowing the operator(s) to take precautionary actions to make sure the device 406/506 is calibrated before it is required to be placed in service. This alert being sent to a back office can be done through a cellular modem, a WiFi connection, through a trackside end- and head-of-train device repeater, or other wireless means.

If the calibration is due at the time of power-up, a disclosed device 406/506 can be further configured to disable further operation on new trips (for example by not allowing the unit to be “armed” to a head-of-train device (as described in AAR Specification S-9152, for instance) until it has been calibrated, or by shutting off the 450 MHz radio of the device, or some other feature disabling means).

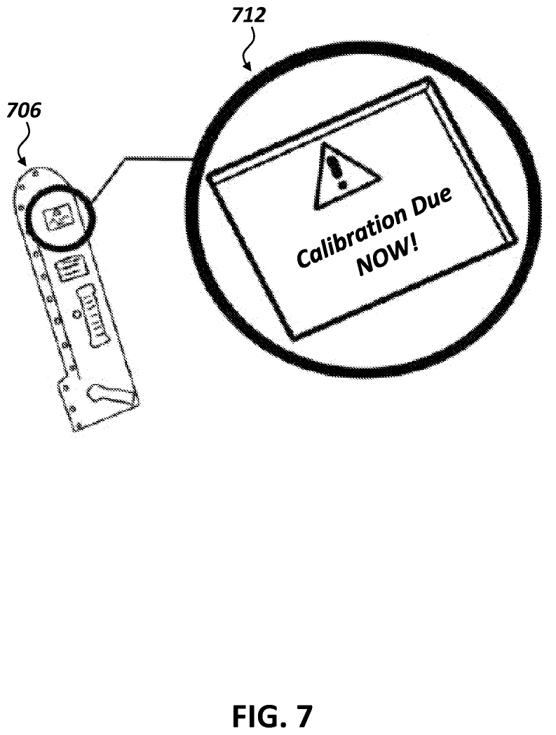

Once a user has been adequately informed of the need to calibrate the device 406/506 (for example by observing alert 712 of FIG. 7 generated and displayed by the device), the device can offer one of several means for allowing the user to indicate they would like to start the calibration process. The user's desired start of a calibration cycle can be indicated and received at the device and/or detected by the processor(s) of the device, which may then initiate a calibration mode automatically. The first user-mediated method of triggering the calibration process can involve rapidly modulating, e.g., increasing and decreasing, the air pressure over a wide range (for example, opening and shutting an air valve to cycle the pressure measured by the device from 0 to 90 PSI several times with a period of several seconds between cycles). The rapid cycling of pressure may be desirable, as this pressure cycling would not be possible in real operation because this cycling of air on a real train would induce the emergency brakes on the train to trigger and stop the train. The second method of triggering the calibration mode can involve plugging a dongle into the end-of-train device that the device (e.g., the processor(s) therein) can recognize as a key to initiate the calibration mode. An additional method of triggering the start of the calibration mode can involve a specific button-press sequence, where the button (e.g., arm/test button 108, 504) of the device is manually held and released in a specific, unique pattern (non-limiting examples may involve holding the button down for 1 second+/−0.25 seconds, then release for 1 second+/−0.25 seconds, and repeat this pattern three times). While there are many methods that could work to trigger the start of a pressure calibration mode, the final method offered for consideration may involve triggering the mode wirelessly from a computer running custom software, such as a phone or tablet (see wireless device 402 of FIG. 4, for example).

Once the trigger to enter calibration mode has been sent to and received by the device, the device may ask (for example, via an instruction displayed on display screen 507) the user to confirm they would like to enter the calibration mode. If a wirelessly connected computer is involved, for example as shown in FIG. 4, much of the interaction will likely occur through the interaction of a user 410 with a custom phone/tablet application (e.g., wireless device 402) configured to run custom software to control the calibration process and communicate with the end-of-train device 406 via a wireless connection 404. Otherwise, the informational display on the device 406 and the arm/test button on the device can be the main human/machine interfaces used. The device 406 can then communicate with a coupled controllable air source 408 to perform the calibration in the calibration mode.

In the case of no external processor being connected or utilized by a disclosed system (via wireless, cabled, or otherwise), such as the system illustrated in FIG. 5, the user can press the arm button (e.g., arm/test button 504) on the end-of-train device 506 to confirm they would like to enter the calibration mode. The end-of-train device 506 can then instruct the user 510 to apply a specific amount of air pressure (for example via the controllable air source 508 with calibrated pressure measurement) to the device 506 (e.g., and confirm when this has been completed (typically with a button press)). Once the user 510 indicates the correct air pressure has been set (the user can use the calibrated air pressure reference measurement of the controllable air source 508 to set this), the end-of-train device 506 can proceed to take at least one measurement of the air pressure (typically many air pressure measurements will be made and averaged during this process) and keep track of it. Once the at least one air pressure measurement has been made, the device can then request the next air pressure setpoint by generating (via the processor(s)) and displaying (via the display screen 507) an instruction for the user (e.g., “Set 90 PSI, then press TEST”). Once the next air pressure has been set (again being set with the reference meter), the user can confirm the air pressure has been set with a button press (at arm/test button 504). Again, the end-of-train device 506 can take at least one measurement, then continue with the process.

Due to the linear nature of most air pressure sensors, the calibration will likely be completed after setting and measuring calibration points at 0 PSI (no air applied/atmosphere) and 90 PSI. While this will likely be enough to create an accurate calibration for many end-of-train devices, there are many ways to create calibrations, and some devices might wish to take measurements at many more points than just one or two, and either create a linear fit, or a polynomial fit. The end-of-train device 506 may thus be configured to control and direct the calibration process through limited interactions with the user and without any external software, processors, or devices, aside from the controllable air source 508.

Once the main calibration sequence has completed and the appropriate calibration constants for the brake line air pressure sensor on the end-of-train device 406/506 have been calculated, the device can optionally perform a “sanity” check on the calibration values to ensure that the hardware is correctly operating within a certain set of limits. In most cases, the calibration of most devices will fall within a certain tolerance as they may be built very similarly and run through a very similar set of circuits on the main processor board within the end-of-train device. When a calibration falls outside of certain limits, it is typically an indication that there is either a problem with the hardware within the end-of-train device, or that the requested pressure setpoints were not correctly set during the calibration process. If the calibration values fall outside of the sanity check tolerance range(s), a disclosed end-of-train device 406/506 can alert the user (via information display 106, 507) to the fact that the calibration process failed to calculate acceptable calibration values, that the values were discarded, and/or that the device was reverting to its last known good calibration values.

Assuming the end-of-train device is able to calculate calibration values that were within a set tolerance, the device can optionally go through another check where it requests the user to set another set of check pressures to confirm the sensor is able to accurately measure pressure at various points. If using a linear calibration with only two points, an embodiment of this invention can request the user to check the pressure at several pressure values that are not the same as the calibration points so as to verify the linear nature of the sensor.

While a disclosed device 406/506 would typically display its measured pressure on its informational displays (e.g., display 507), the optimal embodiment of the field air pressure calibration invention can simply have the air pressure flash dashes (“- -”) on the air pressure or informational display 507 throughout the entire calibration process so as to force the user to rely on the calibrated air pressure sensor and not mistakenly reference the air pressure measurement on the device.

Upon completion of the air pressure calibration routine, the information about the calibration needs to be recorded. In the case of preexisting devices, for example as shown in FIG. 6, the calibration information is written on a sticker 612 that is affixed to the end-of-train device 606. While the person calibrating the device can still update the information in this manner, the embodiments disclosed herein would have the device automatically record the calibration information to its internal non-volatile memory. The recorded calibration information can include: the date and time of the calibration, the location of the calibration (assuming the end-of-train device has access to its location via GPS, cell phone triangulation, etc.), the time the next calibration will be due, and any values used to calculate the calibration (including any measured pressure values, requested setpoints, final calibration values, etc.). As shown in FIG. 7, information about the calibration of the disclosed device 706 can then be displayed on the device's information display screen 712.

A further step that can be implemented in accordance with the present disclosure is to report the calibration into a remote central office via a cell phone, Wi-Fi network, or other wireless connection. By reporting the calibration into a central office, the owners of the device can gain insight into when they might need to intervene to make sure the device gets calibrated before someone is in a rush to get it deployed on a train and ends up causing a delay due to not having a calibrated device available.

As noted above, a user who needs to calibrate the air pressure sensor on an end-of-train device can trigger the start of the calibration process. Some methods of triggering the beginning of an air pressure measurement session can include: ramping the air pressure to the device up and down rapidly (as this would not be something the device could see in normal operation) then requesting a button press (e.g., at button 504) from the user to confirm the triggering of the calibration mode, plugging a dongle into the device, pressing the arm/test button (e.g., at button 504) on the device in a specific sequence, using a cell phone or tablet application and wirelessly triggering the calibration mode (FIG. 4), or any number of other methods.

Once the air calibration mode has been entered, the end-of-train device 406/506/706 can use its informational display to guide the user with calibration instructions. The steps can include requesting the user to set specific air pressures and confirming they had been set. Throughout the process, a disclosed end-of-train device 406/506/706 can be completing air pressure measurements to be able to compare against the requested setpoints.

Upon completion of the guided steps, the end-of-train device (e.g., device 406/506/706) or wireless device (e.g., device 402) can calculate calibration values (they could be a simple offset, a linear calibration, a linear fit with multiple calibration points, a polynomial calibration, etc.). The end-of-train device 406/506/706 and/or wireless device 402 can then check the calibration values to make sure they are within a certain tolerance that would indicate the hardware is working properly and that the user was likely to have set the requested pressures properly.

If the air pressure calibration appeared to calculate acceptable calibration values, the end-of-train device 406/506/706 can then accept the values and indicate the completion of the calibration on the information display of the device (e.g., display 106/507,712), or it can proceed to a confirmation phase in which the device 406/506/706 can request the user to set another series of air pressures, for which it can confirm that the calibration is within a certain tolerance.

An example of the air pressure check can involve the device 406/506/706 requesting a set PSI of 0, then 10, then 30, then 90, etc. Once the device 406/506/706 has confirmed the measurements of the pressure are within a certain tolerance, the device can then complete the air pressure calibration and alert the user to the passing or failing of the calibration on the informational display (e.g., display 106/507/712).

After completion of the brake line air pressure calibration sequences and validations, a full time checking of the air pressure calibration can be performed by a disclosed device. Pursuant to this aspect of the invention, the air pressure measurement being presented by the brake line pressure sensor can be continually compared against voltage and RPM information coming from the air turbine generator (e.g., air turbine generator 206).

To implement this final check, the voltage and RPM coming from the air turbine can be measured either during the air pressure sensor calibration, at the same times and points for which the air pressure sensor measurements are being made, or the air turbine generator can be characterized during a different calibration to know what RPM and what voltage the air turbine generator produces over a range of air pressures (typically 0 PSI to 90 PSI). Another method of characterizing the air generator can involve allowing it to auto-characterize its voltage vs. pressure and RPM vs. pressure over the next week or so after the pressure sensor has been calibrated. If the week-long auto-characterization is implemented, the device may lock into this characterization and not change again until a new calibration cycle of the pressure sensor and turbine occurs. The auto-characterization of the turbine voltage and RPM vs. the pressure sensor can be a completed by a disclosed end-of-train device through a normal operation, as a train's brake line slowly increases in pressure as the train is getting ready to start moving.

Once the turbine characterization vs. pressure has been completed, and the brake line air pressure sensor has been completed, the self-test features of a disclosed end-of-train device can engage to start checking for a pressure sensor becoming out of tolerance vs. the air turbine generator's specifications. If either unit fails, a disclosed end-of-train device can generate and display/transmit an alert to let the user know that the device needs to be examined and calibrated. Through this last check, it is very likely that an air brake line pressure sensor would not need a fixed date for its next calibration and should be able to become exempt from federal rules and regulations that require an annual calibration of the air pressure sensor since it is continually checking itself versus a completely unrelated system. If an annual calibration were to not be required, this information could be either placed on a permanent sticker on the device or shown in the display of a disclosed device.

In the case of the device determining that it needs to be calibrated, the display can indicate as much during startup and during run time, and the device can again be configured to no longer allow an further usage until a new calibration has been completed and the system is back to indicating it is functioning properly (all turbine voltage, RPM, and pressure sensor readings were in tolerance of each other again).

### EXAMPLES AND IMPROVEMENTS

All preexisting calibration systems for the brake line pressure sensor of train require a combination of equipment that is typically only offered in a benchtop environment, remote from the actual train. Such equipment, shown in FIG. 3, includes a personal computer running custom software (computer 302) from the vendor of the end-of-train device (device 306), a connection from the computer to the end-of-train device (connection 304), a source of air pressure (air pressure source 308), and a calibrated air pressure sensor reference (also included in air pressure source 308).

Once the appropriate equipment is gathered and setup, preexisting devices all appear to be calibrated in roughly the same way, in which the software drives the process and contains these rough steps: 1) The software instructs a user to put a specified amount of air pressure to the device (e.g., “Please apply 10 PSI to the end-of-train device”), and asks for confirmation when this has been completed. 2) After confirmation of the first step, the software asks the end-of-train device what it is measuring the air pressure to be before calibration. 3) The software then instructs the user to put a different specified amount of air pressure on the end-of-train device (e.g., “Please apply 90 PSI to the end-of train device”). 4) After confirmation that the second air pressure has been applied to the end-of-train device, the software again asks the device what measurement it is getting for the air pressure. 5) Once the appropriate number of measurements have been gathered for the calibration scheme of the device (for example a linear calibration would only require two point, but could use many more to do a linear fit, and a polynomial calibration would require three or more points), the software uses the known and measured quantities to come up with some sort of calibration constants to ensure the sensor is calibrated to within the required accuracy of the AAR/FRA specifications. 6) Once he appropriate number of measurements have been gathered for the calibration scheme of the device (for example a linear calibration would only require two points, but could use many more to do a linear fit, and a polynomial calibration would require three or more points), the software uses the known and measured quantities to come up with some sort of calibration constants to ensure the sensor is calibrated to within the required accuracy of the AAR/FRA specifications. 7) The final step of a preexisting calibration is that the person calibrating the device will apply a sticker to the unit specifying when the calibration was completed, by whom, and when the next calibration is due (as shown in FIG. 6).

The inventive devices, systems, and methods disclosed herein offer many major advantages over such preexisting methods of calibrating the air pressure sensors on end-of-train devices approved by the American Association of Railroads. For example, the disclosed devices, systems, and methods allow for the device (e.g., device 406/506/706) to be easily calibrated by any user in a field as long as they have an air source with a calibrated air pressure sensor that can be used as a reference. This will dramatically improve efficiency and safety in the rail industry by allowing units that have fallen out of calibration to be quickly and easily calibrated by any field personnel. The disclosed technology also enables the ability for each railroad to exclude further usage of an end-of-train device after the device's calibration has reached its expiration date. The device can be further configured to prevent further arming, or immediately shut down to further usage, or simply warn the user without shutting down. Another advantageous feature of the disclosed technology includes the ability to display calibration information on a uniquely configured display screen of the end-of-train device (display screen 712, for e.g.). This is a marked improvement over the attachment of a sticker (sticker 612, for e.g.) to an external surface of an end-of-train device (device 606, for e.g.), as calibration stickers are frequently worn off of the devices due to abrasion, weather, abuse, etc. Using a disclosed display to show calibration information, instead of a sticker, also allows the disclosed devices to update the next calibration due date without a user being required to have a fresh calibration sticker and pen available to them. Another advantage of the disclosed technology includes having the calibration information available in the unit and on the display, which makes it easier to warn users of a pending calibration expiration, and also makes sure a user will see that a calibration has expired when that occurs. Users of preexisting devices can easily miss when a device's calibration has expired. As another advantage, because embodiments of the disclosed end-of-train devices can be utilized for sensor calibration without the input of any external computers, custom software may no longer be needed and/or maintained by the vendors of end-of-train devices, thereby easing development and reducing the number of deliverables to customers. Additionally, the disclosed devices, systems, and methods make it easier to find more information about previous calibrations through the information stored in internal log files on a disclosed device and through information contained in back office reports stored in a central database that stores information about end-of-train devices and their usage.

In various examples where components, systems and/or methods are implemented using a programmable device, such as a computer-based system or programmable logic, it should be appreciated that the above-described systems and methods can be implemented using any of various known or later developed programming languages, such as “C”, “C++”, “C#”, Java, “VHDL” and the like. Accordingly, various storage media, such as magnetic computer disks, optical disks, electronic memories and the like, can be prepared that can contain information that can direct a device, such as a computer, to implement the above-described systems and/or methods. Once an appropriate device has access to the information and programs contained on the storage media, the storage media can provide the information and programs to the device, thus enabling the device to perform functions of the systems and/or methods described herein. For example, if a computer disk containing appropriate materials, such as a source file, an object file, an executable file or the like, were provided to a computer, the computer could receive the information, appropriately configure itself and perform the functions of the various systems and methods outlined in the diagrams and flowcharts above to implement the various functions. That is, the computer could receive various portions of information from the disk relating to different elements of the above-described systems and/or methods, implement the individual systems and/or methods and coordinate the functions of the individual systems and/or methods described above.

In view of this disclosure it is noted that the various methods and devices described herein can be implemented in hardware, software, and/or firmware. Further, the various methods and parameters are included by way of example only and not in any limiting sense. In view of this disclosure, those of ordinary skill in the art can implement the present teachings in determining their own techniques and needed equipment to affect these techniques, while remaining within the scope of the invention. The functionality of one or more of the processors described herein may be incorporated into a fewer number or a single processing unit (e.g., a CPU) and may be implemented using application specific integrated circuits (ASICs) or general purpose processing circuits which are programmed responsive to executable instructions to perform the functions described herein.

Of course, it is to be appreciated that any one of the examples, examples or processes described herein may be combined with one or more other examples, examples and/or processes or be separated and/or performed amongst separate devices or device portions in accordance with the present systems, devices and methods.

Finally, the above-discussion is intended to be merely illustrative of the present systems and methods and should not be construed as limiting the appended claims to any particular example or group of examples. Thus, while the present system has been described in particular detail with reference to exemplary examples, it should also be appreciated that numerous modifications and alternative examples may be devised by those having ordinary skill in the art without departing from the broader and intended spirit and scope of the present systems and methods as set forth in the claims that follow. Accordingly, the specification and drawings are to be regarded in an illustrative manner and are not intended to limit the scope of the appended claims.

What is claimed is:

1. An end of train device programmed to calibrate a brake line pressure sensor of the end of train device, comprising:
a sensor configured to measure the brake line pressure of the train;
one or more processors configured to:
implement a calibration of the sensor;
guide a user through the calibration of the sensor by generating calibration instructions and receiving user input responsive to the instructions; and
acquire calibration data during the calibration;
a memory configured to store the acquired calibration data; and
a display screen on the end of train device configured to display the calibration instructions.

2. The device of claim 1, wherein the calibration instructions comprise a request to provide the sensor with at least one pressure setpoint.

3. The device of claim 2, wherein the one or more processors are further configured to cause the sensor to acquire at least one pressure measurement of a controlled air pressure applied to the sensor for each pressure setpoint.

4. The device of claim 3, wherein the calibration data comprises calibration values determined by comparing the at least one pressure setpoint with the at least one pressure measurement acquired by the sensor on the end of train device.

5. The device of claim 4, wherein the one or more processors are further configured to determine whether the calibration values are within a defined tolerance range.

6. The device of claim 5, wherein the one or more processors are further configured to cause the display screen to display an alert if the calibration values are not within the defined tolerance range.

7. The device of claim 1, wherein the calibration data comprises calibration values, a calibration status, a date and time of the calibration, a location of the calibration, a time until a next calibration is due, a pressure measurement obtained during the calibration, and/or a pressure setpoint entered by the user during the calibration.

8. The device of claim 1, wherein the one or more processors are further configured to transmit the calibration data to a remote office.

9. The device of claim 1, wherein the one or more processors are configured to initiate the calibration of the sensor by at least one of: detecting a rapid air pressure modulation caused by the user, detecting a dongle attachment to the device, detecting a manual button-press sequence received at an arm button on the device, and/or receiving a command from a wirelessly coupled device.

10. The device of claim 1, wherein the one or more processors are further configured to cause the sensor to acquire at least one pressure measurement of a controlled air pressure applied to the sensor and compare the at least one air pressure measurement against voltage and RPM signals from an air turbine generator on the end of train device.

11. The device of claim 10, wherein the one or more processors are configured to determine if the compared values are within a defined tolerance range based on specifications for the air turbine generator.

12. The device of claim 1, wherein the one or more processors are further configured to cause the display screen to display an alert based on a time remaining until a next calibration is due.

13. The device of claim 1, wherein the one or more processors are further configured to disable the device when calibration is overdue.

14. A system programmed to calibrate a brake line pressure sensor of an end of train device, comprising:
a controllable air source;
a sensor on the end of train device configured to measure brake line air pressure applied by the controllable air source;
a first processor on the end of train device configured to:
implement a calibration of the sensor; and
acquire calibration data during the calibration; and
a second processor wirelessly coupled to the end of train device configured to:
guide a user through the calibration of the sensor by generating calibration instructions and receiving user input responsive to the instructions; and
display calibration instructions on a display screen.

15. The system of claim 14, wherein the calibration instructions comprise a request to provide the sensor with at least one pressure setpoint.

16. The system of claim 14, wherein the one or more processors are configured to initiate the calibration of the sensor by detecting a rapid air pressure modulation caused by the user, detecting a dongle attachment to the device, detecting a button-press sequence received at an arm button on the device, and/or receiving a command from a wirelessly coupled device.

17. A method of calibrating a brake line pressure sensor on an end of train device, comprising:
initiating a calibration mode on the end of train device, wherein the device houses the brake line pressure sensor;
guiding a user through a calibration of the brake line pressure sensor by generating and displaying calibration instructions on the device;
requesting at least one pressure setpoint be provided to the brake line pressure sensor;
acquiring at least one pressure measurement of the defined brake line air pressure;
acquiring calibration data by comparing the at least one pressure measurement to the at least one pressure setpoint;
storing the calibration data within the device; and
displaying the calibration instructions.

18. The method of claim 17, wherein initiating the calibration mode on the device comprises detecting a rapid air pressure modulation caused by the user, detecting a dongle attachment to the device, detecting a button-press sequence received at an arm button on the device, and/or receiving a command from a wirelessly coupled device.

19. The method of claim 17, further comprising disabling the device when calibration is overdue.
